(19) United States
(12) Patent Application Publication
(10) Pub. No.: US 2008/0097813 A1
(43) Pub. Date: Apr. 24, 2008

(54) SYSTEM AND METHOD FOR OPTIMIZING ADVERTISEMENT CAMPAIGNS ACCORDING TO ADVERTISER SPECIFIED BUSINESS OBJECTIVES

(76) Inventors: Robert J. Collins, Brookfield, NH (US); Adam J. Wand, Carlsbad, CA (US)

Correspondence Address: YAHOO! INC.;C/O DREIER LLP, 499 PARK AVENUE, NEW YORK, NY, 10022, US

(21) Appl. No.: 11/962,920

(22) Filed: Dec. 21, 2007

Related U.S. Application Data
(63) Continuation-in-part of application No. 11/321,729, filed on Dec. 28, 2005.

(51) Int. Cl. G06Q 10/00; G06Q 30/00

(52) U.S. Cl. 705/8

(57) ABSTRACT

The present invention relates to methods, systems, and computer readable media comprising instructions for generating a media plan for distributing one or more advertisements comprising an advertisement campaign. The method of the present invention comprises retrieving one or more advertiser specified business objectives for the advertisement campaign and retrieving an advertiser specified budget, as well as an advertiser specified budget allowance for the advertisement campaign. One or more relative values are identified for one or more advertising metrics based upon the one or more advertiser specified business objectives for the advertisement campaign. A score is generated for each of the one or more advertisements comprising the advertisement campaign based upon the one or more relative values and the one or more advertisements comprising the advertisement campaign are sorted based upon the generated scores. One or more of the advertisements are thereafter selected for inclusion in a media plan for distributing the advertisements until the advertiser specified budget has been exhausted. One or more additional advertisements are thereafter selected for inclusion in the media plan for distributing the advertisements until the advertiser specified budget allowance is exceeded or until the advertiser specified business objectives have been obtained.

The present application is a Continuation-in-Part of U.S. application Ser. No. 11/321,729 filed Dec. 28, 2005, the disclosure of which is hereby incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

Advertisements are commonly used on the Internet to promote various products and services. Advertisements may comprise banner ads, links to web pages, images, video, text, etc. The various advertisements used to promote products on the Internet may be displayed according to a variety of formats, such as in conjunction with a ranked result set in response to a query, embedded in a web page, a pop-up, etc. The advertisements displayed to a user of a client device may be selected, redirecting a user to a website providing the product or service advertised.

An advertisement campaign may include a set of one or more advertising activities or conduct directed to accomplishing an advertising goal, such as the marketing or sales of a particular product, service, or content, or a group of products, services or content. The success of an advertising campaign depends on making the most efficient possible use of an advertising budget so as to maximally influence audience behavior. For example, if a campaign is directed to selling a product, then the advertiser may seek to use a given budget to purchase advertising so as to cause a maximum amount of consumers to purchase the product. Determining how to efficiently and optimally spend an advertising budget, as well as implementing and managing an ongoing advertising campaign utilizing such a budget, can pose a daunting challenge to advertisers.

Increasingly, advertising campaigns include online or Internet-based advertising. With ever-increasing Internet use, it is only natural that greater advertising resources are directed to this growing audience. Furthermore, Internet-based advertising allows great opportunities for advertisers to deliver much more targeted, relevant ads than conventional, off-line advertising techniques, such as billboards and the like.

An increasingly important area of advertising includes sponsored listings. Such listing can be presented, for example, in the form of sponsored links appearing among the results of a search conducted using an Internet-based search engine, such as Yahoo!, Ask Jeeves, etc. For instance, auction-based systems exist in which advertisers bid to be included among the sponsored search results for a particular search term or terms, and for the ranking or position of the placement of their sponsored listing among such results.

Online advertisers participating in such an auction-based system may face the challenge of managing and optimizing the ongoing bid process, for example, managing and optimizing thousands or hundreds of thousands of search terms or groups of search terms. Moreover, an advertiser may need to manage and optimize numerous advertising campaigns across numerous disparate advertising channels. A “channel” includes, but is not limited to, a particular entity, organization, or the like, through which advertising may be conducted. In the on-line advertising context, for example, channels can include web sites or search engines such as Yahoo!, MSN, CNN, etc.

While methods exist for the automatic bidding and maintenance of advertisement campaigns, current techniques do not provide advertisers with the ability to specify one or more business objectives that a given advertiser wishes to obtain. For example, different advertisers may have varying business objectives with respect to advertisements that are displayed to users. A first given advertiser may wish to have its advertisements displayed to at least a predetermined number of users at a maximum cost specified by the advertiser. Alternatively, a second given advertiser may wish to have the display of its advertisements result in the purchase of a predetermined number of products sold by the advertiser. Accordingly, while both the first and second advertiser may wish to have their advertisements displayed to users, the business objectives of each respective advertiser are unique. Further, both the first and second advertiser may wish to increase or decrease the amount of money they spend on their advertising based upon whether their business objectives are met.

Current methods and systems for selecting advertisements for delivery to users from a plurality of advertisements fail to take into account advertiser specified business objectives associated with one or more advertisements. Further, current methods and systems for selecting advertisements for delivery do not allow for the modification of a given advertiser's budget on the basis of obtaining one or more advertiser specified business objectives. In order to overcome shortcomings associated with existing advertisement selection and delivery techniques, embodiments of the present invention provide systems and methods for identifying importance values for one or more advertisements on the basis of one or more advertiser specified business objectives, and modifying a given advertiser specified budget on the basis of obtaining the one or more advertiser specified business objectives.

### SUMMARY OF THE INVENTION

The present invention is directed towards systems, methods, and computer readable media comprising program code for generating a media plan for distributing one or more advertisements comprising an advertisement campaign. The method of the present invention comprises retrieving one or more advertiser specified business objectives for the advertisement campaign. According to one embodiment of the present invention, the one or more advertiser specified business objectives comprise advertiser specified target values for one or more advertising metrics for the advertisement campaign.

An advertiser specified budget and an advertiser specified budget allowance are also retrieved, wherein an advertiser specified budget allowance comprises an amount by which the advertiser specified budget may be increased in order to obtain the one or more advertiser specified business objectives.

One or more relative values are thereafter identified for one or more advertising metrics based upon the one or more advertiser specified business objectives. According to one embodiment of the present invention, the one or more relative values comprise importance values identifying the relative importance of one or more advertising metrics. According to another embodiment of the present invention, the one or more relative values comprise relative numerical values of one or more advertising metrics.

A score is generated for each of the one or more advertisements comprising the advertisement campaign based upon the one or more relative values. The score may comprise an efficiency value identifying the relative efficiency of a given advertisement. One or more advertisements are thereafter selected for inclusion in a media plan for distributing the advertisements until the advertiser specified budget has been exhausted. One or more additional advertisements may be selected until the advertiser specified business objectives have been obtained or until the advertiser specified budget allowance has been exceeded.

According to another embodiment, the method of the present invention comprises receiving an advertiser specified budget, budget allowance, and business objective. An expected performance of the one or more advertisements comprising the advertisement campaign with respect to an advertising metric associated with the advertiser specified business objective is thereafter determined. One or more of the advertisements are selected for inclusion in a media plan for distributing the advertisements until the advertiser specified budget has been exhausted, wherein the selection of the one or more advertisements is based upon the determined expected performance of each of the one or more advertisements. One or more additional advertisements are thereafter selected for inclusion in the media plan for distributing the advertisements until the advertiser specified business objective has been obtained or until the advertiser specified budget allowance is exceeded, wherein the selection of the one or more additional advertisements is based upon the determined expected performance of each of the one or more additional advertisements

The system of the present invention comprises a value component operative to retrieve one or more advertiser specified business objectives for an advertisement campaign and identify one or more relative values for one or more advertising metrics based upon the one or more advertiser specified business objectives for the advertisement campaign. According to one embodiment of the present invention, the value component is operative to retrieve one or more advertiser specified target values for one or more advertising metrics. According to another embodiment of the present invention, the value component is operative to identify one or more importance values or value guidelines identifying the relative importance and relative numerical value, respectively, of one or more advertising metrics.

The system of the present invention further comprises a spend planner component operative to retrieve an advertiser specified budget and an advertiser specified budget allowance for the advertisement campaign. The spend planner component is further operative to generate a score, which may comprise an efficiency value, for each of the one or more advertisements comprising the advertisement campaign based upon the one or more relative values identified by the value component.

The spend planner component is operative to thereafter sort the one or more advertisements comprising the advertisement campaign based upon the scores associated with the one or more advertisements. The spend planner then selects one or more of the advertisements for inclusion in a media plan for distributing the advertisements until the advertiser specified budget has been exhausted. The spend planner component thereafter may continue to select one or more additional advertisements until the advertiser specified business objectives have been obtained or until the advertiser specified budget allowance has been exceeded.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting a system for generating media plans for one or more advertisements according to one or more advertiser specified business objectives and an advertiser specified budget, according to one embodiment of the present invention;

FIG. 2 is a flow diagram presenting one embodiment of a method for generating a media plan for distributing one or more advertisements comprising an advertisement campaign based upon one or more advertiser specified business objectives, according to one embodiment of the present invention;

FIG. 3 is a flow diagram presenting one embodiment of a method for selecting advertisements for inclusion in a media plan for distributing advertisements based upon one or more advertiser specified business objectives and an advertiser specified budget allowance, according to one embodiment of the present invention; and

FIG. 4 is a screen diagram illustrating one embodiment of an interface for identifying one or more advertiser specified business objectives for a given advertisement campaign, according to one embodiment of the present invention.

### DETAILED DESCRIPTION OF THE EMBODIMENTS

In the following description of the embodiment of the invention, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

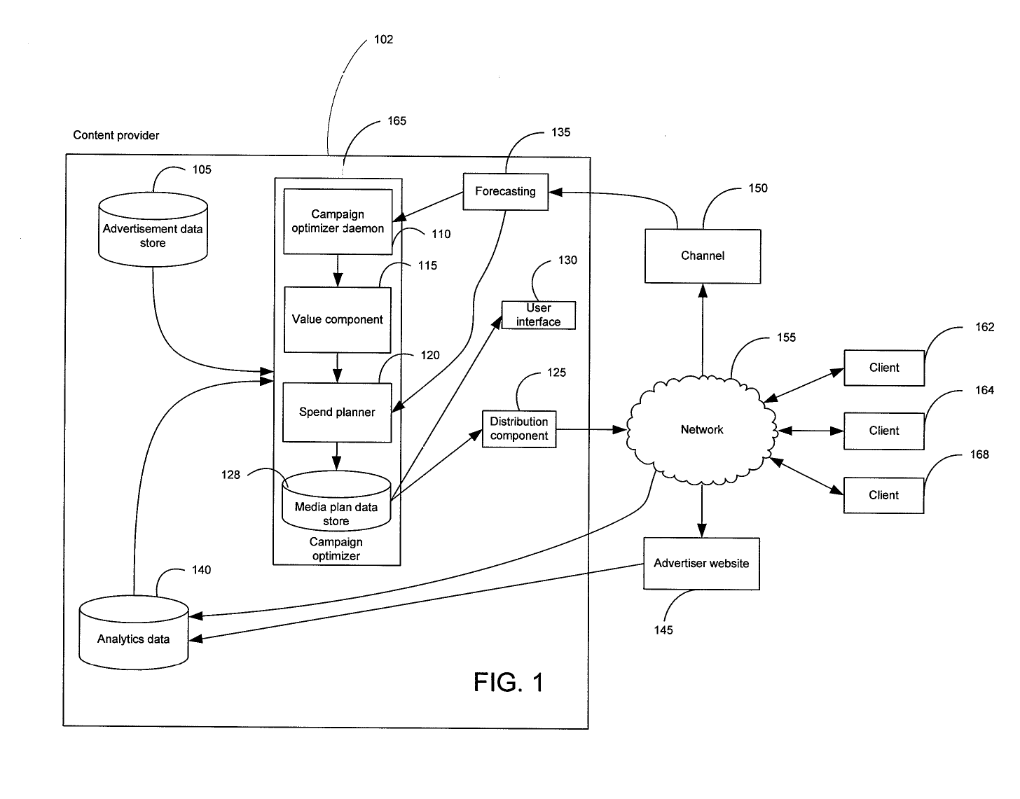

FIG. 1 is a block diagram illustrating a system for generating one or more media plans for the delivery of one or more advertisements according to one or more advertiser specified business objectives and an advertiser specified budget. According to the embodiment of FIG. 1, one or more advertisement campaigns comprising one or more advertisements are stored in an advertisement data store 105 at a content provider 102. Advertising campaigns may include a variety of advertisements, including but not limited to sponsored search listings or links to an advertiser's webpage.

A user interface 130 at the content provider 102 allows an advertiser associated with a given advertisement campaign to specify one or more business objectives for the one or more advertisements comprising a given advertisement campaign. According to one embodiment of the present invention, an advertiser specified business objective may comprise an indication of the target cost per thousand impressions (“CPM”), target cost per user selection of an advertisement (“CPC”), target cost per acquisition or conversion (“CPA”), target return on advertisement spend (“ROAS”) for the one or more advertisements in a given advertisement campaign, or a target minimum position at which one or more advertisements are displayed in a ranked list of advertisements in response to a given term. Cost per thousand impressions refers to the cost for displaying one or more advertisements in an advertisement campaign one thousand times. Cost per user selection of an advertisement, or “click,” refers to the cost for a user selection of an advertisement in a given advertisement campaign. Cost per acquisition refers to an advertiser's cost for each acquisition, conversion, or purchase of a product for which the advertiser has advertised. Return on advertisement spend refers to the revenue earned on one or more advertisements displayed to users. For example, advertisers may have a plurality of advertisements to display to users of client devices in response to various search requests. Furthermore, advertisers may pay a fee for displaying advertisements in response to various search requests. While an advertiser may display a plurality of advertisements directed at various products offered by the advertiser, only a few of the advertisements displayed may result in actual purchases. An advertiser may want to ensure that the amount of money earned on purchases exceeds the amount of money spent on advertising. According to methods described herein, an advertiser may specify the return on advertisement spend for one or more advertisements.

An advertiser may specify a target business objective for each of the abovementioned advertising metrics. For example, through use of the user interface 130 at the content provider 102, an advertiser may specify that the advertiser's business objective for impressions is twenty three cents ($0.23) per thousand impressions (“CPM”), indicating that the advertiser wishes to have its advertisements displayed to users at a target cost of twenty three cents ($0.23). Similarly, through use of the user interface 130 at the content provider 102, an advertiser may specify that the advertiser's business objective for conversions is twenty seven dollars ($27) per conversion (“CPA”), indicating that the target amount that the advertiser wishes to spend on advertisements for each user purchase of a product is twenty seven dollars ($27).

In addition to one or more business objectives, an advertiser may also specify a budget through use of the user interface 130 at the content provider. According to one embodiment of the present invention, a budget specified by an advertiser comprises a maximum dollar amount that the advertiser wishes to spend upon its advertisements. An advertiser may further specify a budget range or budget allowance, indicating an amount by which the advertiser is willing to increase its budget in order to obtain its one or more business objectives. For example, as previously described, and advertiser may specify a business objectives for a thousand impressions, such as the value ten cents ($0.10), indicating that the advertiser wishes to have its advertisements displayed at a cost of ten cents ($0.10) per thousand impressions. The advertiser may further specify that as long as its business objective of ten cents ($0.10) is not exceeded, its budget may be increased by up to twenty percent (20%). For example, the advertiser may specify that its budget is $1,000, however, provided that is business objective of ten cents is not exceeded, its budget may be increased by 20% to $1,200. Alternatively, or in conjunction with the foregoing, the advertiser specified budget allowance may be utilized in the event that the advertiser specified business objective is obtained. For example, the advertiser may specify that its budget is $1,000, however, in the event that its business objective of ten cents is met, its budget may be increased by 20% to $1,200.

The one or more advertiser specified business objectives, budget, and budget range may be maintained in the advertisement data store 105 in conjunction with the advertisement campaigns with which such business objectives, budget, and budget range are associated. The advertiser specified business objectives, as well as the advertiser specified budget information, may be used to place bids on search terms or groups of terms that when used in a search query cause the display of an advertiser's advertisements or links to advertisements among the displayed results. Bids may also be made to secure prominence and positions for an advertiser's one or more advertisements in response to a given search query. For example, an advertiser may desire to display a given advertisement or group of advertisements in response to one or more terms and may further desire to display the advertisement in a particular position of a result set that a search engine returns. Through the use of a marketplace or auction-based system, bids may be placed on the one or more terms corresponding to the advertisements the advertiser wishes to display.

An analytics data store 140 at the content provider 102 is operative to store click through data for the one or more advertisements stored in the advertisement data store 105. According to one embodiment of the invention, the analytics data store 140 maintains data on the number of times a given advertisement was displayed, the frequency with which a given advertisement was selected, and the frequency with which a given advertisement resulted in a user purchasing making a purchase.

The analytics data store 140 may comprise an accessible memory structure such as a database, CD-ROM, tape, digital storage library, etc., and may be implemented as a database or any other type of data storage structure capable of providing for the retrieval and storage of a variety of data types. The analytics data store 140 may also store a variety of data related to advertisements. Information in the analytics data store 140 may be maintained in advertisement groups according to advertiser, product, category, keywords, funnel values or a combination thereof.

One or more advertisements, advertiser specified business objectives, and budget information for a given advertisement campaign are delivered to a campaign optimizer 165 at the content provider 102. According to one embodiment of the present invention, a value component 115 at the campaign optimizer 165 is operative to generate value guidelines and importance values for one or more advertising metrics through use of the one or more advertiser specified business objectives, wherein a value guidelines comprises the relative value of a given advertising metrics, and an importance value comprises the relative importance of a given advertising metric. For example, an advertisement campaign delivered to the value component 115 may be associated with an advertiser specified business objective of one dollar ($1) for CPC (“cost per click”). Accordingly, the value component 115 may indicate that the advertising metric CPC has “high” importance, whereas the remaining advertising metrics associated with the advertising campaign may have less importance, such as “low” or “not important” for the advertising metrics CPM, CPA, and ROAS.

Further, the value component 115 may indicate that the relative value associated with the advertising metric CPC for the advertising campaign is 5, the relative value associated with the advertising metric CPM the advertising campaign is 2, and the relative value associated with conversions is 1, indicating that the value of user selection of an advertisement from the advertising campaign is two and one-half (2.5) times greater than the value of an impression, and five (5) times greater than the value of a conversion.

The importance and relative values associated with the advertising metrics and the advertiser specified budget are thereafter delivered to a spend planner component 120 at the campaign optimizer 165. The spend planner component 120 is operative to generate one or more execution plans identifying the execution parameters for one or more advertisements in a given advertisement campaign according to an advertiser's budget and based upon the importance and relative values assigned to the one or more advertising metrics associated with the campaign.

For example, as previously described an advertiser may set a target business objective of one dollar ($1.00) per thousand impressions (“CPM”). Accordingly, the value component 115 may indicate that the importance value associated with impressions is high, whereas the importance values associated with clicks (CPC) and conversions (CPA) are low or not important. Further, the value component 115 may indicate that the relative value of impressions is twice the value of conversions, and three times the value of clicks. The execution parameters that the spend planner component 120 generates may accordingly indicate that impressions are to occur more frequently based upon the importance and relative values for the advertising metric CPM. Alternatively, or in conjunction with the foregoing, the execution parameters that the spend planner component 120 generates may indicate that the advertiser specified budget is to be utilized to a greater extent for impressions (CPM) than for other advertising metrics, such as conversions (CPA) or user selections of advertisements (CPC).

The one or more execution parameters for a given execution plan generated by the spend planner component 120 are annotated with forecast data from a forecasting component 135. According to one embodiment of the invention, the spend planner component 120 delivers one or more keywords associated with displaying one or more advertisements in a given advertising campaign to the forecasting component 135. The forecasting component 135 is operative to retrieve information regarding the one or more advertisements displayed in response to the one or more keywords delivered to the forecasting component 135.

The forecasting component 135 retrieves information for one or more advertisements for one or more advertising metrics, such as CPA, CPC, CPM, as well as the bid associated with a given advertisement and its position in a ranked list of advertisements. For example, the spend planner component 120 may deliver the key words “notebook computer” to the forecasting component 135. The forecasting component 135 may retrieve historical information regarding the one or more advertisements displayed in response to the key words “notebook computer”, the bids associated with the one or more advertisements, as well as the position of the one or more advertisements in a ranked list of advertisements.

The forecasting component 135 may further be operative to retrieve historical data for one or more advertising metrics regarding the one or more advertisements displayed in response to the key words “notebook computer.” For example, the forecasting component 135 may retrieve historical data indicating that a given advertisement received two hundred impressions, eighty user selections, and twenty conversions. The forecast component 135 may retrieve historical data from the analytics data store 140 indicating the number and type of advertising events obtained at various bid amounts for one or more key words, as well as the position of one or more advertisements in a ranked list of advertisements displayed in response to the given key words. According to one embodiment of the invention, the forecast component 135 calculates the average number of advertising metric events obtained at various bid amounts for the one or more advertisements displayed in response to one or more key words to provide a forecast of the expected number of advertising metric events that may be obtained at various bid amounts.

The various execution parameters generated by the spend planner component 120 for a given execution plan are annotated by the spend planner component 120 with the forecast data from the forecasting component 135. For example, the execution parameters for a given execution plan may identify various bid amounts associated with the one or more advertisements in the execution plan. The forecast data as obtained from the forecasting component 135 may be used to annotate the execution parameters at each respective bid amount and may indicate the varying levels of advertising metric events that may be obtained at varying bid amounts. According to one embodiment of the invention, the forecast data may indicate the number of impressions, clicks, and conversions obtained one or more bid amounts. Table A illustrates an exemplary execution plan wherein advertisements are annotated with forecast data from the forecasting component 135.

TABLE A

| | Bid associated with | | Average forecast |
|---|---|---|---|
| | the one or more | Average | values for |
| | key words for | position in | advertisement at |
| Adver- | displaying the | ranked list of | bid amount and |
| tisement | advertisment | advertisements | position |
| A1 | $2.50 | 7 | Impressions: 200 |
| | | | Clicks: 18 |
| | | | Conversions: 2 |
| A2 | $1.50 | 5 | Impressions: 300 |
| | | | Clicks: 28 |
| | | | Conversions: 4 |
| A3 | $2.00 | 3 | Impressions: 500 |
| | | | Clicks: 86 |
| | | | Conversions: 12 |

The one or more execution parameters annotated with forecast data may be further annotated with advertisement specific analytics data stored in the analytics data store 140. According to one embodiment of the invention, the analytics data store 140 maintains information identifying the various advertising events associated with a given advertisement. For example, the analytics data store 140 may indicate that a given advertisement displayed in response to the key words “notebook computer” resulted in forty user selections and twelve purchases with an associated bid of $4. The forecast data obtained from the forecasting component 135, however, may indicate that the average advertisement displayed in response to the term “notebook computer” at a bid of $4 resulted in three hundred user selections and four purchases. Therefore, the execution parameters for the one or more advertisements in a given advertiser's budget are annotated with advertisement specific analytics data to provide a more accurate prediction of the number of advertising events a given advertisement obtains when displayed in response to a given one or more key words at a given bid amount.

The spend planner component 120 uses the annotated execution parameters of the one or more execution plans, as well as a given advertiser's budget and budget range to generate one or more media plans. A media plan generated by the spend planner component 120 identifies the optimal execution parameters used in conjunction with a given set of advertisements in an advertiser's budget. According to one embodiment of the invention, a media plan identifies the optimal bid amounts for terms in response to which the advertisements in a given advertiser's budget are to be displayed according to the one or more advertiser specified business objectives.

The spend planner component 120 generates one or more media plans with execution parameters that attempt to achieve the one or more advertiser specified business objectives. Further, as previously described, an advertiser may specify a budget, which identifies the maximum dollar value an advertiser is willing to spend on one or more advertisements in one or more campaigns. The spend planner component 120 is operative to formulate one or more media plans that apportion a given advertiser's budget, ensuring that a given budget is not exceeded and to optimize the likelihood that a given advertiser's business objectives are obtained.

According to one embodiment of the present invention, the spend planner component 120 generates one or more media plans with execution parameters that increase the likelihood that a given advertiser's business objectives are obtained and utilize the entirety of a given advertiser's budget. According to another embodiment of the present invention, the spend planner component generates one or more media plans with execution parameters that increase the likelihood that a given advertiser's business objectives are obtained and continues to increase the advertiser's budget within the advertiser's budget range until the advertiser's business objectives are obtained or the advertiser's budget range has been exhausted. According to yet another embodiment of the present invention, the spend planner component 120 generates one or more media plans with execution parameters that increase the likelihood that a given advertiser's business objectives are obtained and increases the advertiser's budget until the advertiser specified business objectives are obtained.

In addition to the foregoing, the spend planner component 120 uses a scoring function to calculate an efficiency value for the one or more advertisements in a given advertisement campaign. The efficiency values associated with the one or more advertisements in a given advertisement campaign are used to select advertisements to be included in a given media plan. According to one embodiment of the invention, the scoring function utilizes the forecasted funnel values, the advertisement specific analytics data, and the importance and relative values for one or more advertising metrics to calculate the efficiency of a given advertisement. According to one embodiment, the one or more advertisements in a given advertiser's advertisement campaign are sorted in descending order by efficiency value.

Advertisements with the greatest efficiency values are selected for inclusion in a given media plan until exhaustion of an advertiser's budget. As previously described, however, an advertiser may specify a budget range or budget allowance. According to one embodiment of the present invention, a budget range comprises an amount by which an advertiser is willing to have its budget increased in order to obtain to the advertiser's business objectives or in the event that the advertiser's one or more business objectives are obtained. For example, as previously described, an advertiser may specify a business objectives for impressions, such as the value ten cents ($0.10), indicating that the advertiser wishes to have its advertisements displayed at a cost of ten cents ($0.10) per thousand impressions. The advertiser may further specify that in order to obtain its business objective, or in the event its business objective of ten cents ($0.10) is met, its budget may be increased by up to twenty percent (20%). For example, the advertiser may specify that its budget is $1,000, however, to meet its business objective of ten cents per thousand impressions, or in the event that its business objective of ten cents per thousand impressions is obtained, its budget may be increased by up to 20%, to $1,200.

In the event that a given advertiser has specified a budget range, advertisements are selected for inclusion in a given media plan until either the one or more advertiser specified business objectives are obtained or the advertiser's budget range has been exhausted. Alternatively, in the event that a given advertiser has set no budget limit, advertisements are selected for inclusion in a given media plan until the one or more advertiser specified business objectives are obtained and the advertiser's budget has been exhausted.

The cost associated with a given advertisement is an emergent property based upon the efficiency value as calculated by the scoring function. The scoring function determines the bid value associated with a given advertisement based upon the calculated efficiency of the advertisement without exceeding a given advertiser's constraints. According to one embodiment of the present invention, the efficiency of a given advertisement is inversely proportional to the bid upon the term in response to which the advertisement is to be displayed. For example, the efficiency of a given advertisement may be maximized at the lowest allowed bid for the term in response to which the advertisement is to be displayed.

The one or more media plans generated by the spend planner component may be stored in the media plan data store 128. According to one embodiment of the invention, each media plan has a set of associated attributes. The attributes associated with a media plan may include, but are not limited to, a name, the budget of the campaign or campaigns for which the media plan was generated and a date, which may indicate the period of time a media plan is to be executed.

Media plans generated by the spend planner component 120 and stored in the media plan data store 128 may be viewed by advertisers through the user interface 130. According to one embodiment of the invention, an advertiser may select a media plan from the media plan data store 128 for execution. According to another embodiment of the invention, the spend planner component 120 selects a media plan from the media plan data store 128 for execution. According to yet another embodiment, the user interface 130 provides an advertiser with the ability to examine the projected outcome of a given media plan without actually executing the media plan. The execution parameters for a given media plan, with annotated forecast values, allow an advertiser to view the projected outcome of the media plan with respect to one or more advertising metrics. According to a further embodiment of the invention, an advertiser may utilize the user interface 130 to increase or decrease the budget associated with one or more advertisements stored in the advertisement data store 105, or to increase or decrease the budget range associated with a given advertiser specified budget to determine how the increase or decrease in budget will affect the performance and outcome of one or more advertisements and to determine how such increases or decreases will affect the likelihood of obtaining the one or more advertiser's specified business objectives.

A media plan selected for execution either by an advertiser using the user interface 130 or by the spend planner component 120, is delivered to the distribution component 125. The distribution component 125 is operative to deliver the one or more advertisements and bid execution parameters of a media plan to one or more channels 150. A channel 150, such as Yahoo.com, may be operative to receive one or advertisements and associated bids and distribute one or more advertisements according to the bids associated with the one or more advertisements. Users of client devices 162, 164 and 168 communicatively coupled to the network 155 may select one or more of the advertisements displayed by a given channel 150 as part of a web page. If a user of a client device 162, 164 and 168 selects an advertisement displayed on a given web page, the user may be redirected to an advertiser's web site 145. User interactions with an advertisement and web page are tracked and may be delivered to the analytics data store 140.

The analytics data delivered to the analytics data store 140 for one or more advertisements in a given advertisement campaign may be utilized by the spend planner component 120 to perform a comparison of the actual performance of the campaign with respect to one or more advertiser specified business objective associated with the campaign. As previously described, an advertiser may specify one or more business objectives. The spend planner component 120 is operative to retrieve the analytics data associated with one or more advertisements in a given campaign and determine the actual performance of the one or more advertisements in the campaign through use of the analytics data. For example, the analytics data for one or more advertisements in a given campaign associated with a budget of $1000 may indicate that the advertisements resulted in 100 conversions. The spend planner component 195 may thus determine that the cost per conversion (“CPA”) associated with the campaign is $10.

The spend planner component 120 may thereafter perform a comparison of the actual performance of a given campaign, as determined from the analytics data, and the one or more advertiser specified business objectives associated with the campaign. Based upon the comparison, the spend planner component 120 may modify one or more of the execution parameters associated with a given media plan in order to increase the likelihood that the one or more advertiser specified business objectives are obtained. Additionally, the spend planner component 120 may increase or decrease a given advertiser's budget within the advertiser's specified budget range based upon the comparison between the advertiser specified business objective and the actual performance of a given campaign, as determined from the analytics data.

The campaign optimizer daemon 110 at the content provider 102 is operative to invoke the spend planner component 120 to generate one or more media plans. According to one embodiment of the invention, the campaign optimizer daemon 110 invokes the spend planner component 120 when a given advertiser adds or deletes one or more advertisements from the advertisement data store 105. According to another embodiment of the invention, the campaign optimizer daemon 110 invokes the spend planner component 120 when an advertiser specifies or modifies one or more business objectives, or updates an existing budget or budget range.

According to yet another embodiment of the invention, the campaign optimizer daemon 110 invokes the spend planner component 120 upon receipt of an alert from the forecasting component 135 indicating a recent deviation in the frequency of search requests for one or more keywords submitted by users of client devices 162, 164 and 168 to one or more channels 150. The forecast component may be operative to monitor one or more channels 150, such as the Yahoo! search engine. The forecasting component 135 may identify significant deviations in search requests for one or more keywords made by users of client devices 162, 164 and 168 and alert the campaign optimizer daemon 110 of such deviations.

According to a further embodiment of the invention, the campaign optimizer daemon 110 invokes the spend planner component 120 at regular intervals, which may be predetermined. Alternatively, or in conjunction with the foregoing, the campaign optimizer daemon 110 invokes the spend planner component 120 when a given media plan is nearing expiration or has expired. For example, a given media plan may execute for a period of twenty-four hours. The campaign optimizer daemon 110 may notify the spend planner component 120 at a given time interval before a given media plan is expiring that a new media plan must be generated.

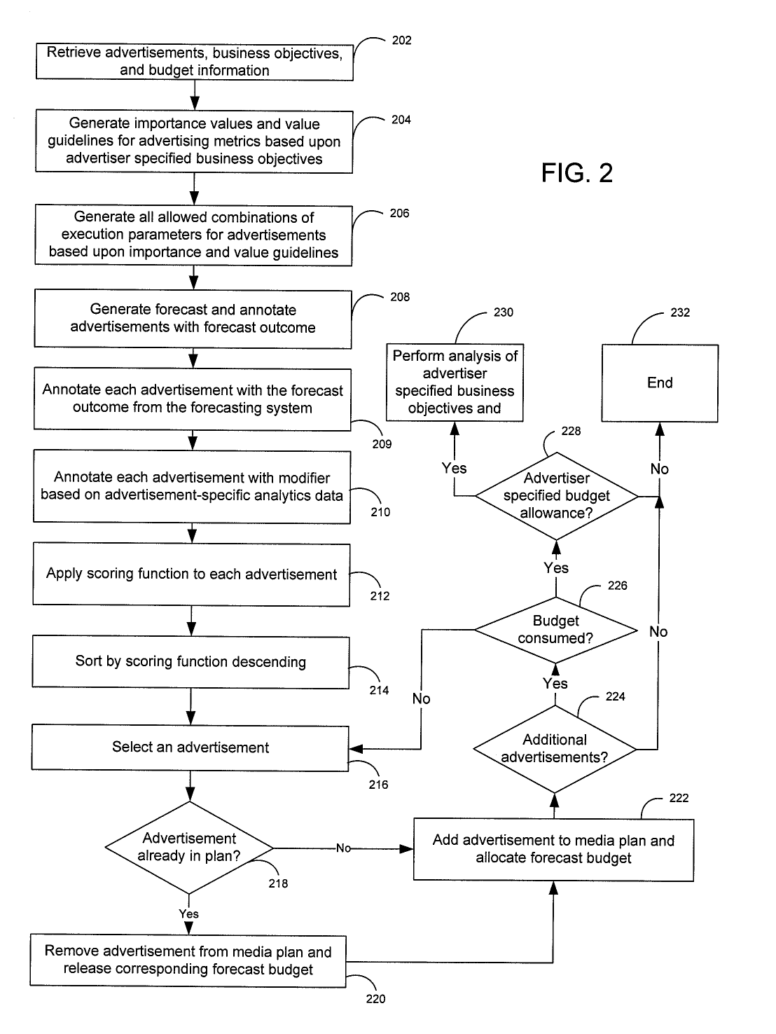

FIG. 2 is a flow diagram presenting one embodiment of a method for generating a media plan for one or more advertisements according to one or more advertiser specified business objectives. According to the embodiment illustrated in FIG. 2, one or more advertisements comprising an advertisement campaign, as well as one or more advertiser specified business objectives and budget information associated with the advertisement campaign are retrieved, step 202. The one or more advertiser specified business objectives may comprise one or more monetary target values for one or more advertising metrics. For example, a given advertiser specified business objective for an advertisement campaign may comprise a target value for impressions, indicating the advertiser's desired cost for the display of a given advertisement from the advertisement campaign. Similarly, a given advertiser specified business objective for an advertisement campaign may comprise a target value for conversions, indicating the advertiser's desired cost for a purchase resulting from the one or more advertisements comprising the advertisement campaign. Alternatively, or in conjunction with the foregoing, an advertiser specified business objective for an advertisement campaign may comprise a target minimum position at which the one or more advertisements comprising the advertisement campaign are to be displayed in response to one or more search terms.

The budget information retrieved in step 202 may comprise an advertiser specified budget and an advertiser specified budget allowance. An advertiser specified budget identifies a maximum dollar amount a given advertiser wishes to spend on one or more advertisements in a given advertisement campaign. According to one embodiment of the present invention, an advertiser specified budget allowance comprises an amount by which the advertiser specified budget for a given advertisement campaign may be increased in order to obtain the one or more advertiser specified business objectives or in the event that the one or more advertiser specified business objectives are obtained.

Importance values and value guidelines are generated for one or more advertising metrics based upon the one or more advertiser specified business objectives, step 204. For example, as previously described, an advertiser specified business objective may comprise a target value for impressions. Accordingly, an importance value of “high” may be assigned to the advertising metric “impressions,” whereas one or more other advertising metrics for which the advertiser has not specified business objectives may be associated with the importance values “low” or “not importance.” Table A illustrates one embodiment of importance values that may be assigned to one or more advertising metrics based upon an advertiser specified business objective.

TABLE B

| Business Objective | Impression | | Conversion |
|---|---|---|---|
| Metric | Importance | Click Importance | Importance |
| CPM | High | Low | Not Important |
| CPC | Low | High | Low |
| CPA | Not Important | Low | High |
| ROAS | Not Important | Low | High |

The metrics CPM, CPC, CPA, and ROAS in the foregoing table correspond to the advertising metrics impressions, user selections/clicks, conversions, and return on advertisement spend, respectively. As illustrated in Table B, an advertiser may specify a business objective per thousand impressions (CPM), which will result in the importance value “high” being assigned to “Impression Importance,” and the values “Low” and “Not Important” being assigned to “Click Importance” and “Conversion Importance,” respectively. Similarly, an advertiser may specify a business objective for user selections/click (CPC), resulting in the importance value “Low” being assigned to “Impression Importance” and “Conversion Importance,” and the importance value “High” being assigned to “Click Importance.”

The importance values associated with the one or more advertising metrics may be used to assign value guidelines for the one or more advertising metrics. According to one embodiment of the present invention, a value guideline comprises the relative value of a given advertising metric, which is based upon the importance associated with the advertising metric as determined from the advertiser specified business objectives. For example, as previously described, an advertiser may provide a business objective for the advertising metric “impressions” (CPM), and accordingly, the advertising metric impressions may be associated with the importance value “high,” whereas the advertising metrics “clicks” and “conversions” are associated with the importance value “low” and “not important,” respectively. The value guidelines which may be assigned to impressions, clicks, and conversions may comprise the numerical values four (4), one (1), and two (2), respectively, indicating that the value of an impression is four times greater than the value of click and is twice the value of a conversion.

One or more execution plans are generated, a given execution plan identifying allowed combinations of execution parameters for the retrieved advertisements based upon the importance values and value guidelines, step 206. According to one embodiment of the present invention, a given execution plan identifies various execution parameters with varying bid amounts for terms in response to which the one or more advertisements are to be displayed. Further, according to one embodiment of the present invention, a given execution plan identifies execution parameters in conjunction with the advertiser specified business objectives. With reference to the foregoing example, the execution parameters may increase the frequency with which advertisements are displayed (impressions) based upon the importance values and value guidelines associated with impressions. Alternatively, or in conjunction with the foregoing, the execution parameters may increase the amount that the advertiser's specified budget utilized for displaying advertisements (impressions) and decrease the amount utilized for conversions and clicks in order to maximize the frequency with which the advertisements are displayed and to maximize the likelihood of obtaining the advertiser specified business objective for a thousand impressions.

The one or more terms in response to which the one or more advertisements are to be displayed may be used to generate a forecast of the performance of the one or more advertisements, step 208. According to one embodiment of the present invention, historical information associated with one or more advertisements displayed in response to a given term is comprises the number of impressions, clicks, conversions, and return on advertisement spend for one or more advertisements displayed in response to a given term.

The execution parameters for the one or more execution plans for the one or more advertisements are annotated with the foregoing forecast data, step 209. For example, a given advertisement may be associated with the term “notebook computer.” The forecast data may indicate that a bid of eighty-nine cents for displaying an advertisement in response to the query “notebook computer” results in the advertisement being displayed four hundred times during a seven day period. The forecast data may further indicate that a bid of eighty-nine cents results in an average of fifty user selections and eight conversions. The execution plan identifying a bid of eighty-nine cents for the term “notebook computer” may be annotated with the corresponding forecast data.

Similarly, the forecast data may indicate that a bid of ninety-three cents for displaying an advertisement in response to the query “notebook computer” results in an advertisement being displayed six hundred times during a seven day period. The forecast data may further indicate that a bid of ninety-three cents for the term “notebook computer” results in an average of eighty user selections and twenty conversions. The execution plan identifying a bid of ninety-three cents for the term “notebook computer” is accordingly annotated with the corresponding forecast data. The various bid execution parameters of the one or more execution plans for the one or more advertisements are annotated with the corresponding forecast data.

The execution parameters of the one or more execution plans for the one or more advertisements may be further annotated with advertisement specific analytics data, step 210. For example, the forecast data may indicate that an advertisement displayed in response to the query terms “notebook computer” at a bid of ninety-five cents will receive an average of one hundred impressions, eighty user selections, and two conversions. However, analytics data may indicate that a given advertisement performed better or worse than indicated by the forecast data. For example, a given advertisement displayed in response to the terms “notebook computer” may have actually received two hundred impressions, ninety user selections, and eight conversions. The execution parameters for the one or more execution plans are thus annotated with advertisement specific analytics data indicating the actual performance of the one or more advertisements in a given execution plan.

A scoring function is applied to the execution parameters of a given execution plan using the forecast data, the advertisement specific analytics data and the previously described importance values and value guidelines associated with one or more advertising metrics, step 212. The scoring function is used to calculate an efficiency value for the one or more advertisements based upon the execution parameters associated with a given advertisement in a given execution plan. Table B illustrates one embodiment of a scoring function that may be used to calculate an efficiency value of a given advertisement based upon the execution parameters of a given execution plan.

TABLE C
$S ( A ) = {\sum }_{m = \{ i , l , a , r \}} ( {F ( {A}_{S} )}_{m} ⨯ {Δ ( A , F ( {A}_{s} ) )}_{m} ⨯ {V ( A )}_{m} )$

In the equation presented in Table C, S is the scoring function, A is a given advertisement, Aₛ is the search term for advertisement A, F is the forecast, A is the advertisement specific modifier based upon a given advertisement's analytics data, V is the value function and m is a given advertising metric (e.g., impressions, clicks, conversions and return on advertisement spend). An efficiency value is calculated for each advertisement in the one or more execution plans, step 212. The one or more advertisements in the one or more execution plans are sorted in descending order according to efficiency value, step 214.

A first advertisement is selected from a given execution plan, step 216. A check is performed to determine whether the advertisement selected is already in the media plan being generated, step 218. If the advertisement selected is not in the media plan, the advertisement is added to the media plan, and the cost associated with the advertisement is removed from the advertiser specified budget, step 222. According to one embodiment of the present invention, the cost associated with a given advertisement is calculated using the forecast data for a given bid amount for the one or more keywords associated with the given advertisement. For example, the forecast data may indicate that the term “notebook computer” costs ten cents per impression and receives an average of one hundred impressions in a given period of time. Based upon the forecast data, at a bid amount of ten cents, an advertiser will be charged $10.00 (e.g., ten cents per impression*100 impressions) for an advertisement displayed in response to the term “notebook computer.”

If the advertisement selected is already in the media plan, the advertisement in the media plan is removed and the cost associated with the removed advertisement is released from the advertiser specified budget, step 220. The selected advertisement is added to the media plan and the cost associated with the selected advertisement is added to the budget, step 222.

A check is thereafter performed to determine whether there are one or more additional advertisements that require analysis, step 224. If no additional advertisements require analysis, processing terminates, and the media plan is complete and may be executed or stored in a data store for later execution or viewing by the advertiser, step 232. Alternatively, if there are one or more additional advertisements that require analysis, a further check is performed to determine whether the advertiser specified budget has been consumed, step 226. If the advertiser specified budget has not been consumed, a next advertisement is selected from among the one or more additional advertisements that require analysis, step 216.

If the advertiser specified budget has been consumed, a check is performed to determine whether the advertiser associated with the one or more advertisements has specified a budget allowance, step 228. If the advertiser associated with the advertisements has not specified any budget allowance, processing terminates, step 232. If the advertiser associated with the one or more advertisements has specified a budget allowance, an analysis is performed with respect to the one or more advertiser specified business objectives, according to methods described herein, step 230. As previously described, according to one embodiment of the present invention, a budget allowance may comprise an amount by which the advertiser specified budget may be increased in order to obtain the advertiser specified business objective or in the event that the one or more advertiser specified business objectives are obtained. For example, a given advertiser may indicate that the advertiser's budget of ten thousand dollars ($10,000) may be exceeded by ten percent (10%) in order to obtain the advertiser's business objective or in the event that the advertiser's specified business objective for conversions is obtained. Similarly, a given advertiser may indicate that the advertiser's budget of five thousand dollars ($5,000) may be exceeded by two thousand dollars ($2,000) in order to obtain the advertiser's business objective for a thousand impressions or in the event that the advertiser's specified business objective for a thousand impressions is obtained.

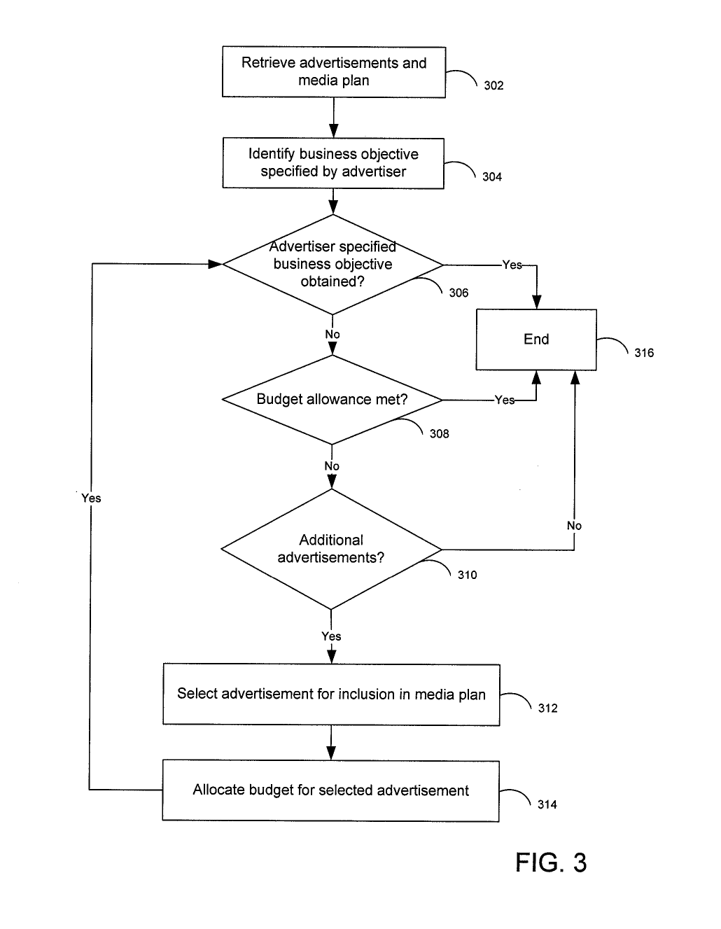

FIG. 3 is a flow diagram illustrating one embodiment for performing an analysis with respect to one or more advertiser specified business objectives and an advertiser specified budget allowance after a given advertiser specified budget has been exceeded for a given media plan. According to the embodiment illustrated in FIG. 3, one or more advertisements from an advertisement campaign for which an advertiser specified budget has been exceeded are retrieved, the one or more advertisements comprising advertisements which have not yet been added to a media plan for the advertisement campaign, step 302.

The advertiser specified business objective associated with the one or more retrieved advertisements is thereafter identified, step 304. As previously described, an advertiser specified business objective may comprise a target value for a given advertising metric, including, but not limited to, impressions, clicks, conversions, return on advertisement spend, or target minimum position that the advertiser wishes to obtain for a given advertisement campaign.

A check is performed to determine whether the advertiser specified business objective has been obtained, step 306. For example, if the advertiser specified a business objective for a thousand impressions, the check at step 306 may comprise a check to determine whether the media plan generated for the one or more advertisements in the advertisement campaign will result in obtaining the advertiser specified business objective for a thousand impressions. If the advertiser specified business objective has been obtained, processing terminates, step 316.

If the advertiser specified business objective has not been obtained, a check is performed to determine whether the advertiser specified budget allowance has been exceeded, step 308. According to one embodiment, a given advertiser specified budget allowance comprises an amount by which the advertiser specified may be increased in order to obtain the advertiser specified business objective. For example, a given advertiser specified budget allowance may comprise a percentage of the advertiser specified budget by which the advertiser's budget may be increased in order to obtain the advertiser specified business objective. Similarly, a given advertiser specified budget allowance may comprise an indication that the advertiser's budget may be increased without limit (“no limit” budget allowance) until the advertiser specified business objective is obtained.

If the advertiser specified budget allowance has been met, processing terminates, step 316. Alternatively, if the advertiser specified budget allowance has not been met, a further check is performed to determine whether one or more additional advertisements are available to be added to the media plan for the advertisement campaign, step 310. If no additional advertisements are available for inclusion in the media plan, processing terminates, step 316.

If one or more additional advertisements are available for inclusion in the media plan for the advertisement campaign, a given advertisement is selected for inclusion in the media plan, step 312. The cost associated with the selected advertisement is thereafter allocated from the budget and budget allowance, step 314. A check is thereafter performed to again determine whether the advertiser specified business objective has been obtained, step 306.

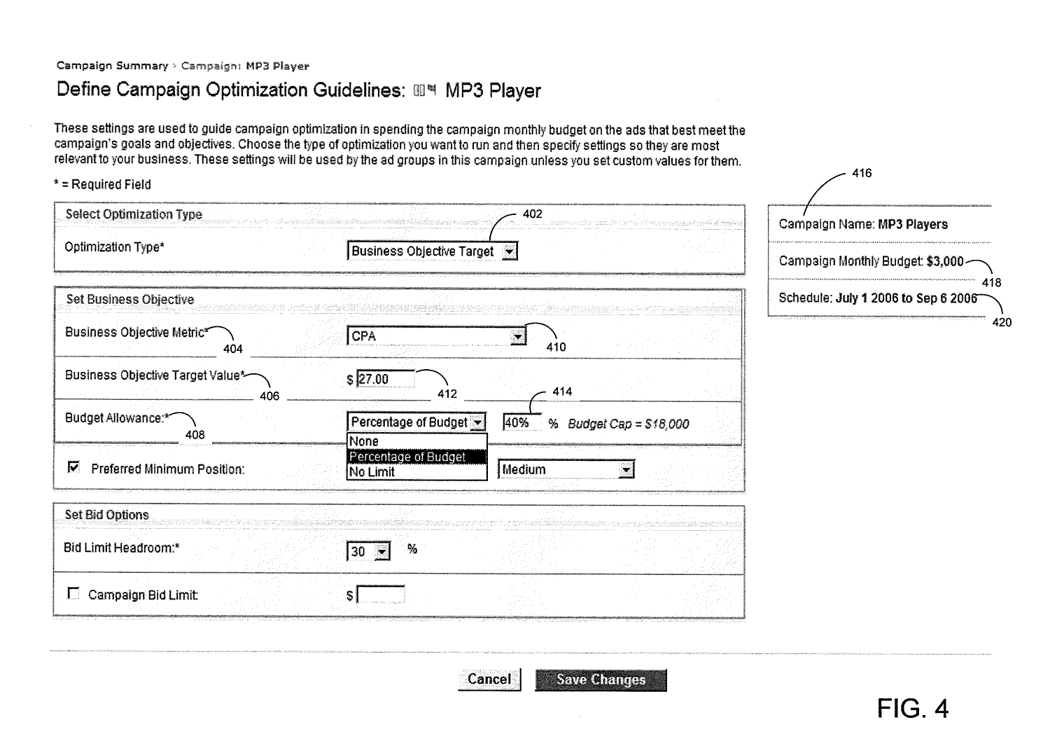

FIG. 4 is a screen diagram illustrating one embodiment of an interface with which an advertiser may identify a business objective for one or more advertisements in a given advertisement campaign. As illustrated in FIG. 4, an advertiser may specify a budget 418 for a given advertisement campaign 416. The advertiser may specify that the budget 418 for the advertisement campaign 416 is applicable for a given time period 420.

As further illustrated in FIG. 4, an advertiser may specify that it wishes to optimize the advertisement campaign 416 for a given business objective 402. The advertiser may thereafter select the advertising metric 404 for which the advertiser wishes to specify a business objective. For example, the one or more advertising metrics available in the menu 410 in FIG. 4 may comprise CPA (cost per acquisition/conversion), CPC (cost per user selection/click), ROAS (return on advertisement spend), and CPM (cost per thousand impressions).

Upon selecting a given business objective metric 404, an advertiser may select a business objective target value 406. As illustrated in FIG. 4, a business objective target value 406 may comprise a numerical value 412 indicating the monetary target value that the advertiser wishes to obtain for the selected advertising metric.

As discussed herein, an advertiser may further identify a budget allowance 408, which according to one embodiment of the present invention, comprises an amount by which the advertiser is willing to increase its budget in order to obtain the advertiser specified business objective target value 406. In the embodiment illustrated in FIG. 4, the advertiser specified budget allowance 408 comprises a percentage of the advertiser specified budget 414. Alternatively, the advertiser specified budget allowance 408 may comprise a “no limit” allowance, indicating that the advertiser's budget may be increased without limit until the advertiser's specified business objective target value 406 is obtained.

FIGS. 1 through 4 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A method for generating a media plan for distributing one or more advertisements comprising an advertisement campaign, the method comprising:
retrieving one or more advertiser specified business objectives for the advertisement campaign;
retrieving an advertiser specified budget and an advertiser specified budget allowance for the advertisement campaign;
identifying one or more relative values for one or more advertising metrics based upon the one or more advertiser specified business objectives for the advertisement campaign;
generating a score for each of the one or more advertisements comprising the advertisement campaign based upon the one or more relative values;
sorting the one or more advertisements comprising the advertisement campaign based upon the scores associated with the one or more advertisements selecting one or more of the advertisements for inclusion in a media plan for distributing the advertisements until the advertiser specified budget has been exhausted; and
selecting one or more additional advertisements for inclusion in the media plan for distributing the advertisements until the advertiser specified budget allowance is exceeded or until the advertiser specified business objectives have been obtained.

2. The method of claim 1 wherein retrieving an advertiser specified business objective comprises retrieving an advertiser specified target value for one or more advertising metrics.

3. The method of claim 1 wherein retrieving an advertiser specified budget allowance comprises receiving an amount by which the advertiser specified budget may be increased in order to obtain the one or more advertiser specified business objectives.

4. The method of claim 1 wherein identifying one or more relative values for one or more advertising metrics comprises identifying one or more importance values identifying a relative importance of one or more advertising metrics based upon the advertiser specified business objectives.

5. The method of claim 1 wherein identifying one or more relative values for one or more advertising metrics comprises identifying one or more value guidelines identifying a relative numerical value of one or more advertising metrics based upon the advertiser specified business objectives.

6. The method of claim 1 wherein generating a score for each of the one or more advertisements comprising the advertisement campaign comprises generating an efficiency value for the one or more advertisements comprising the advertisement campaign.

7. A system for generating a media plan for distributing one or more advertisements comprising an advertisement campaign, the method comprising:
a value component operative to:
retrieve one or more advertiser specified business objectives for the advertisement campaign; and
identify one or more relative values for one or more advertising metrics based upon the one or more advertiser specified business objectives for the advertisement campaign; and
a spend planner component operative to:
retrieve an advertiser specified budget and an advertiser specified budget allowance for the advertisement campaign;
generate a score for each of the one or more advertisements comprising the advertisement campaign based upon the one or more relative values;
sort the one or more advertisements comprising the advertisement campaign based upon the scores associated with the one or more advertisements;
select one or more of the advertisements for inclusion in a media plan for distributing the advertisements until the advertiser specified budget has been exhausted; and
select one or more additional advertisements for inclusion in the media plan for distributing the advertisements until the advertiser specified budget allowance is exceeded or until the advertiser specified business objectives have been obtained.

8. The system of claim 7 wherein the value component is operative to retrieve one or more advertiser specified target values for one or more advertising metrics.

9. The system of claim 7 wherein the value component is operative to identify one or more importance values identifying a relative importance of one or more advertising metrics based upon the one or more advertiser specified business objectives.

10. The system of claim 7 wherein the value component is operative to identify one or more value guidelines identifying a relative numerical value of one or more advertising metrics based upon the one or more advertiser specified business objectives.

11. The system of claim 7 wherein the spend planner component is operative to generate an efficiency value for each of the one or more advertisements comprising the advertisement campaign.

12. The system of claim 7 wherein the spend planner component is operative to:
select an advertisement for inclusion in a media plan based upon the scores associated with the one or more advertisements;
allocate a cost associated with including the selected advertisement in the media plan from the advertiser specified budget;
determine whether the advertiser specified budget has been exhausted; and
determine whether the advertiser specified business objective has been obtained.

13. A computer readable media comprising program code that when executed instructs a processor to perform a method for generating a media plan for distributing one or more advertisements comprising an advertisement campaign, the method comprising:
instructions for retrieving one or more advertiser specified business objectives for the advertisement campaign;
instructions for retrieving an advertiser specified budget and an advertiser specified budget allowance for the advertisement campaign;
instructions for identifying one or more relative values for one or more advertising metrics based upon the one or more advertiser specified business objectives for the advertisement campaign;
instructions for generating a score for each of the one or more advertisements comprising the advertisement campaign based upon the one or more relative values;
instructions for sorting the one or more advertisements comprising the advertisement campaign based upon the scores associated with the one or more advertisements instructions for selecting one or more of the advertisements for inclusion in a media plan for distributing the advertisements until the advertiser specified budget has been exhausted; and
instructions for selecting one or more additional advertisements for inclusion in the media plan for distributing the advertisements until the advertiser specified budget allowance is exceeded or until the advertiser specified business objectives have been obtained.

14. The computer readable media of claim 13 wherein the instructions for retrieving comprise instructions for retrieving an advertiser specified target value for one or more advertising metrics.

15. The computer readable media of claim 13 wherein the instructions for receiving comprise instructions for receiving an amount by which the advertiser specified budget may be increased in order to obtain the one or more advertiser specified business objectives.

16. The computer readable media of claim 13 wherein the instructions for identifying one or more relative values for one or more advertising metrics comprises instructions for identifying one or more importance values identifying a relative importance of one or more advertising metrics based upon the advertiser specified business objectives.

17. The computer readable media of claim 13 wherein the instructions for identifying one or more relative values for one or more advertising metrics comprises instructions for identifying a relative numerical value of one or more advertising metrics based upon the advertiser specified business objectives.

18. The computer readable media of claim 13 wherein the instructions for generating a score for each of the one or more advertisements comprising the advertisement campaign comprises instructions for generating an efficiency value for the one or more advertisements comprising the advertisement campaign.

19. A method for generating a media plan for distributing one or more advertisements comprising an advertisement campaign, the method comprising:
receiving an advertiser specified budget, budget allowance, and business objective;
determining an expected performance of the one or more advertisements comprising the advertisement campaign with respect to an advertising metric associated with the advertiser specified business objective;
selecting one or more of the advertisements for inclusion in a media plan for distributing the advertisements until the advertiser specified budget has been exhausted, wherein the selection of the one or more advertisements is based upon the determined expected performance of each of the one or more advertisements; and
selecting one or more additional advertisements for inclusion in the media plan for distributing the advertisements until the advertiser specified business objective has been obtained or until the advertiser specified budget allowance is exceeded, wherein the selection of the one or more additional advertisements is based upon the determined expected performance of each of the one or more additional advertisements
